(19) United States
(12) Patent Application Publication
(10) Pub. No.: US 2010/0202613 A1
(43) Pub. Date: Aug. 12, 2010

(54) PACKET BUNDLING AT THE PDCP LAYER WITH CIPHERING ON THE PDCP SDU

(75) Inventors: Siddharth Ray, Bridgewater, NJ (US); Ashwin Sampath, Skillman, NJ (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/652,656

(22) Filed: Jan. 5, 2010

Related U.S. Application Data
(60) Provisional application No. 61/143,132, filed on Jan. 7, 2009.

(51) Int. Cl. H04L 9/00

(52) U.S. Cl. 380/270

(57) ABSTRACT

Certain aspects of the present disclosure propose techniques for bundling and ciphering service data units (SDU) in the packet data convergence protocol (PDCP) layer. The proposed techniques increase the data rate of the communication system. At the transmitter side, the PDCP layer may bundle SDUs and cipher each SDU individually before submitting them to a lower layer. At the receiver-side, the PDCP layer may unbundle and decipher the SDUs before submitting them to higher layers.

### CLAIM OF PRIORITY UNDER 35 U.S.C. §119

The present application for patent claims benefit of U.S. Provisional Patent Application Ser. No. 61/143,132 filed Jan. 7, 2009, entitled, “Packet Bundling at the PDCP Layer with Ciphering on the PDCP SDU,” and assigned to the assignee hereof and hereby expressly incorporated by reference herein.

### TECHNICAL FIELD

Certain aspects of the present disclosure generally relate to wireless communications and, more particularly, to bundling and ciphering service data units (SDUs) in a communication layer.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input-single-output, multiple-input-single-output or a multiple-input-multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≧min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

For some wireless applications, security is not necessary and data may be transmitted without encryption between a UE and an access network. However, for certain applications, it may be necessary for “sensitive” data to be transmitted over the air. Examples of such sensitive data may include personal information, credit card information, account information, and so on. For sensitive data, encryption may be used to provide security for the over-the-air transmission.

### SUMMARY

Certain aspects of the present disclosure provide a method for wireless communications. The method generally includes ciphering one or more received service data units (SDUs) in a first communication layer, concatenating the ciphered SDUs to generate a bundle, generating a header for the bundle, and submitting the header and the bundle to a second communication layer.

Certain aspects of the present disclosure provide a method for wireless communications. The method generally includes receiving a protocol data unit (PDU) bundle in a first communication layer, wherein the PDU bundle comprises a header and one or more service data units (SDUs), extracting information about the SDUs from the header, extracting the SDUs from the PDU bundle using the information extracted from the header, deciphering each of the SDUs using the information extracted from the header, and submitting the deciphered SDUs to a higher communication layer.

Certain aspects of the present disclosure provide an apparatus for wireless communications. The apparatus generally includes logic for ciphering one or more received service data units (SDUs) in a first communication layer, logic for concatenating the ciphered SDUs to generate a bundle, logic for generating a header for the bundle, and logic for submitting the header and the bundle to a second communication layer.

Certain aspects of the present disclosure provide an apparatus for wireless communications. The apparatus generally includes logic for receiving a protocol data unit (PDU) bundle in a first communication layer, wherein the PDU bundle comprises a header and one or more service data units (SDUs), logic for extracting information about the SDUs from the header, logic for extracting the SDUs from the PDU bundle using the information extracted from the header, logic for deciphering each of the SDUs using the information extracted from the header, and logic for submitting the deciphered SDUs to a higher communication layer.

Certain aspects of the present disclosure provide an apparatus for wireless communications. The apparatus generally includes means for ciphering one or more received service data units (SDUs) in a first communication layer, means for concatenating the ciphered SDUs to generate a bundle, means for generating a header for the bundle, and means for submitting the header and the bundle to a second communication layer.

Certain aspects of the present disclosure provide an apparatus for wireless communications. The apparatus generally includes means for receiving a protocol data unit (PDU) bundle in a first communication layer, wherein the PDU bundle comprises a header and one or more service data units (SDUs), means for extracting information about the SDUs from the header, means for extracting the SDUs from the PDU bundle using the information extracted from the header, means for deciphering each of the SDUs using the information extracted from the header, and means for submitting the deciphered SDUs to a higher communication layer.

Certain aspects of the present disclosure provide a computer-program product for wireless communications, comprising a computer-readable medium having instructions stored thereon, the instructions being executable by one or more processors. The instructions generally include instructions for ciphering one or more received service data units (SDUs) in a first communication layer, instructions for concatenating the ciphered SDUs to generate a bundle, instructions for generating a header for the bundle, and instructions for submitting the header and the bundle to a second communication layer.

Certain aspects of the present disclosure provide a computer-program product for wireless communications, comprising a computer-readable medium having instructions stored thereon, the instructions being executable by one or more processors. The instructions generally include instructions for receiving a protocol data unit (PDU) bundle in a first communication layer, wherein the PDU bundle comprises a header and one or more service data units (SDUs), instructions for extracting information about the SDUs from the header, instructions for extracting the SDUs from the PDU bundle using the information extracted from the header, instructions for deciphering each of the SDUs using the information extracted from the header, and instructions for submitting the deciphered SDUs to a higher communication layer.

Certain aspects of the present disclosure provide an apparatus for wireless communications. The apparatus generally includes at least one processor configured to cipher one or more received service data units (SDUs) in a first communication layer, concatenate the ciphered SDUs to generate a bundle, generate a header for the bundle, and submit the header and the bundle to a second communication layer.

Certain aspects of the present disclosure provide an apparatus for wireless communications. The apparatus generally includes at least one processor configured to receive a protocol data unit (PDU) bundle in a first communication layer, wherein the PDU bundle comprises a header and one or more service data units (SDUs), extract information about the SDUs from the header, extract the SDUs from the PDU bundle using the information extracted from the header, decipher each of the SDUs using the information extracted from the header, and submit the deciphered SDUs to a higher communication layer.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in accordance with certain aspects of the present disclosure.

FIG. 2 illustrates a block diagram of a communication system, in accordance with certain aspects of the present disclosure.

FIG. 3 illustrates user plane protocol stack for a transmitter and a receiver in the LTE standard.

FIG. 4 illustrates an example block diagram of a packet data convergence protocol (PDCP) layer architecture.

FIG. 5 illustrates an example block diagram for the proposed PDCP layer architecture, in accordance with certain aspects of the present disclosure.

FIG. 6 illustrates example PDCP service data units (SDU) and a PDCP protocol data unit (PDU), in accordance with certain aspects of the present disclosure.

FIG. 7 illustrates an example format for the COUNT variable, in accordance with certain aspects of the present disclosure.

FIG. 8 illustrates an example flow diagram for bundling with individual ciphering on each PDCP SDU, in accordance with certain aspects of the present disclosure.

FIG. 9 illustrates example operations for ciphering and bundling service data units, in accordance with certain aspects of the present disclosure.

FIG. 9A illustrates example components capable of performing the operations illustrated in FIG. 9.

FIG. 10 illustrates an example flow diagram for unbundling with individual deciphering for each PDCP SDU, in accordance with certain aspects of the present disclosure.

FIG. 11 illustrates example operations for unbundling and deciphering service data units, in accordance with certain aspects of the present disclosure.

FIG. 11A illustrates example components capable of performing the operations illustrated in FIG. 11.

FIG. 12 illustrates an example bundling format where ciphering is done individually on each PDCP SDU, in accordance with certain aspects of the present disclosure.

### DETAILED DESCRIPTION

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

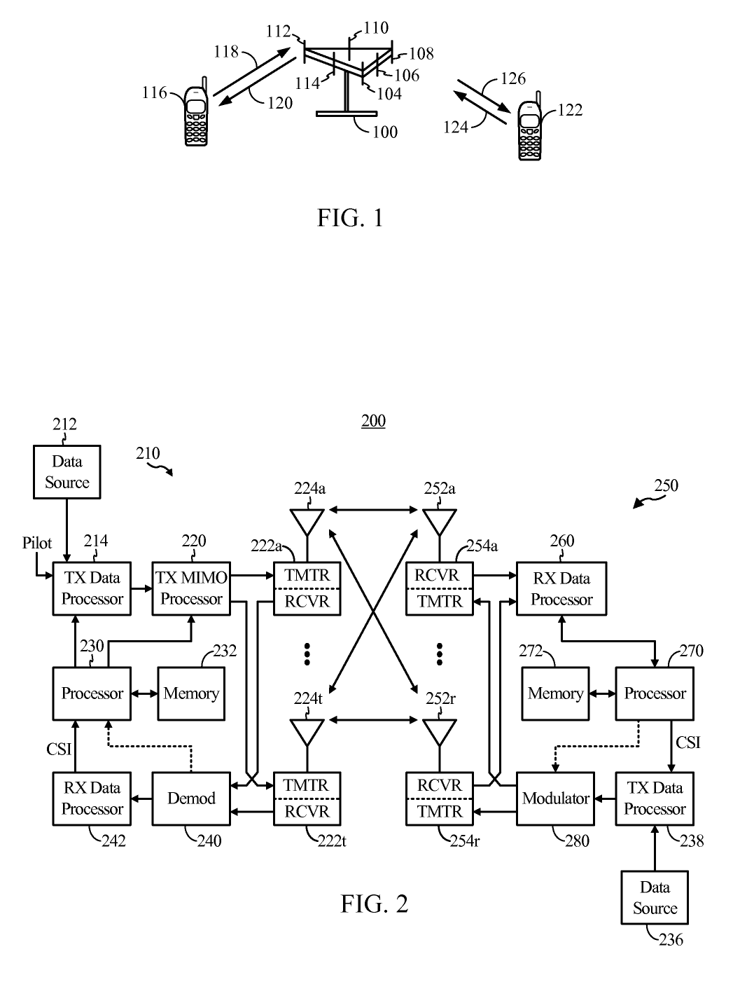

Referring to FIG. 1, a multiple access wireless communication system according to one aspect is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the aspect, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

FIG. 2 is a block diagram of an aspect of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222a through 222t receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

### Packet Bundling at the PDCP Layer with Ciphering on the PDCP SDU

Certain aspects of the present disclosure propose techniques for bundling and ciphering packets in a communication layer to reduce the just-in-time processing complexity of transmit and receive data paths and increase security of the system.

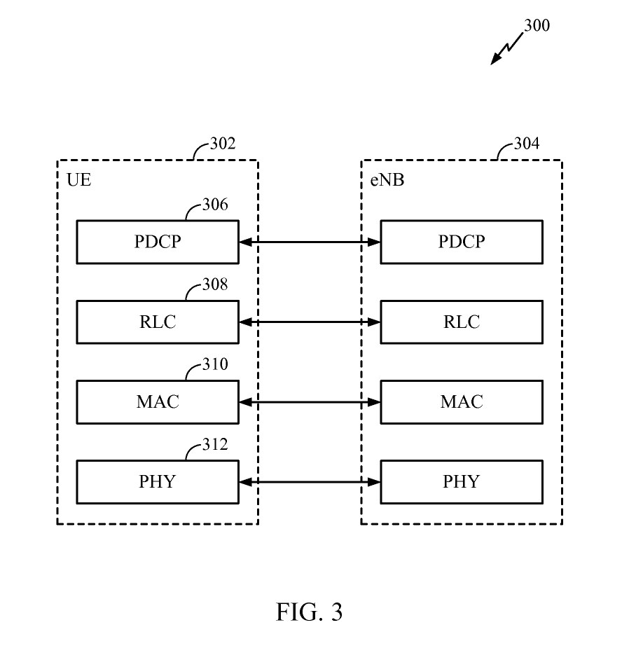

In a wireless communication system, transmitters and receivers may communicate through a multiple layer protocol stack. FIG. 3 illustrates user plane protocol stack for a user equipment (UE) 302 and an evolved node B (eNB) 304 in the LTE standard. The protocol stack may include a packet data convergence protocol (PDCP) layer 306, a radio link control (RLC) layer 308, a medium access control (MAC) layer 310 and a physical (PHY) layer 312. The physical layer performs the physical transport of data between the UE and the eNB.

In the transmitter side, each layer receives service data units (SDUs) from a higher layer, adds headers to the SDUs to generate protocol data units (PDU), and sends the PDUs to a lower layer. The PDUs are treated as SDUs by the lower layer.

For a typical data transmission, the PDCP layer receives packets (PDCP SDU) from an upper layer and processes them into PDCP PDUs which are submitted to a lower layer. As specified currently in the 3GPP specifications, the mapping between the PDCP SDU and the PDCP PDU is a one-to-one relationship. Therefore, every PDCP PDU is generated from exactly one PDCP SDU.

Similarly, on the receiver side, the PDCP layer receives packets (PDCP PDUs) from a lower layer and extracts a PDCP SDU for further processing at the upper layer. As specified currently in the 3GPP specifications, the mapping between the PDCP PDU and the PDCP SDU is a one-to-one relationship. Therefore, every PDCP SDU is generated from exactly one PDCP PDU.

As generally used in the following description, an SDU is any packet that is received from an upper layer in the transmitter side or passed to an upper layer in the receiver side, whereas a PDU is a packet generated by a layer and passed on to a lower layer in the transmitter side or received from a lower layer in the receiver side.

Therefore, for example, a PDCP PDU is an RLC SDU in the transmitter side. Similarly, an RLC PDU is a MAC SDU, and so forth. In general, each layer in the transmitter side may add information, typically in the form of a header, to SDU data to generate a PDU and pass it to a lower layer.

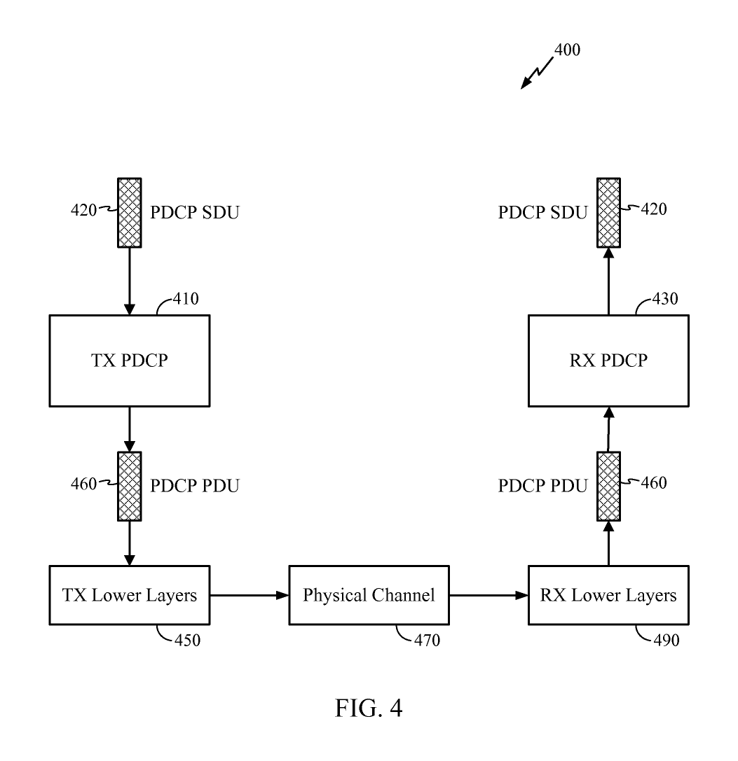

FIG. 4 illustrates a block diagram of transmission and reception by a PDCP layer. At the transmitter side, the PDCP layer 410 receives a packet (PDCP SDU 420) for processing from an upper layer. The PDCP layer processes the packet into a PDCP PDU 460 which may be submitted to a lower layer 450. The packet may then be transmitted through a physical channel 470. In this architecture, a single PDCP PDU 460 is generated from exactly one PDCP SDU 420.

Similarly, on the receiver side, the PDCP layer receives a packet (PDCP PDU 460) from a lower layer 490 and extracts the PDCP SDU 420 to send to an upper layer for further processing. Since the mapping between the PDCP PDU and PDCP SDU is a one-to-one relationship, every PDCP SDU is generated from exactly one PDCP PDU.

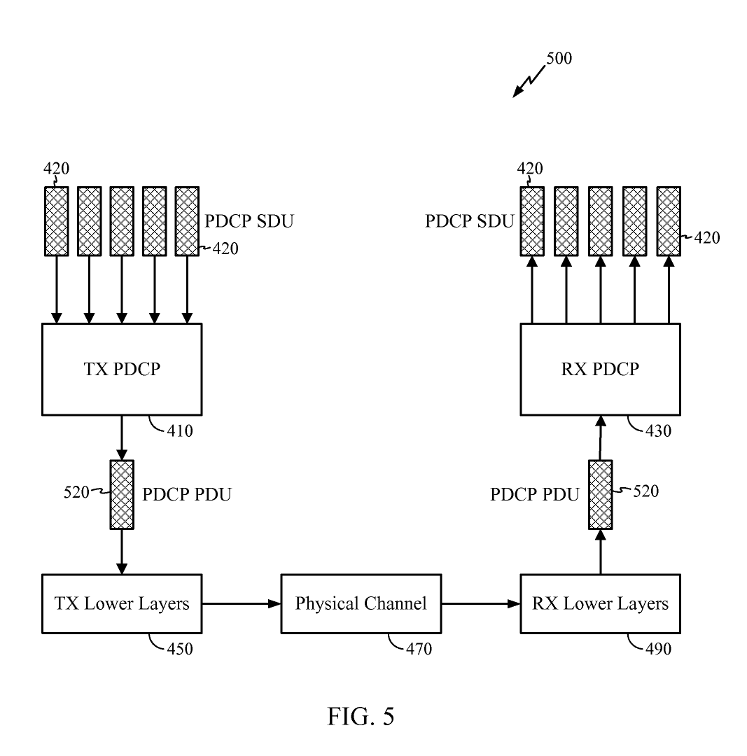

FIG. 5 illustrates a block diagram of packet transmission and reception in the proposed PDCP layer architecture 500, in accordance with certain aspects of the present disclosure. At the transmitter side, the PDCP layer 410 receives one or more packets (PDCP SDUs 420) for processing from an upper layer.

Although only five PDCP SDUs are illustrated in this figure, an arbitrary number of PDCP SDUs may be received and processed at the PDCP layer. The PDCP layer may concatenate one or more PDCP SDUs to generate a PDCP PDU 520 before submitting to a lower layer.

For certain aspects of the present disclosure, the mapping between PDCP SDUs and PDCP PDUs may be many-to-one. Therefore, each PDCP PDU may be generated from one or more PDCP SDUs. The bundling of multiple PDCP SDUs into a single PDCP PDU at the PDCP layer may be accomplished in many ways. For certain aspects, the bundling may be accomplished prior to the processing operations in the PDCP layer. For certain aspects, the bundling may be performed in between various PDCP processing operations. For certain aspects, the bundling may be performed after PDCP processing operations.

The PDCP PDU 520 may be submitted to the lower layers 450 for transmission through a physical channel 470. In the proposed scheme, a single PDCP PDU 520 is generated from one or more PDCP SDUs 420.

Similarly, on the receiver side, the PDCP layer receives a packet (PDCP PDU 520) from a lower layer 490 and extracts one or more PDCP SDUs 420. For certain aspects of the present disclosure, the mapping between the PDCP PDU and PDCP SDU may be a one-to-many relationship. Therefore, one or more PDCP SDUs may be extracted from every received PDCP PDU.

For certain aspects, similar to the transmitter side, the unbundling of multiple PDCP SDUs from a single PDCP PDU may be accomplished prior to, after or in between processing operations in the PDCP layer.

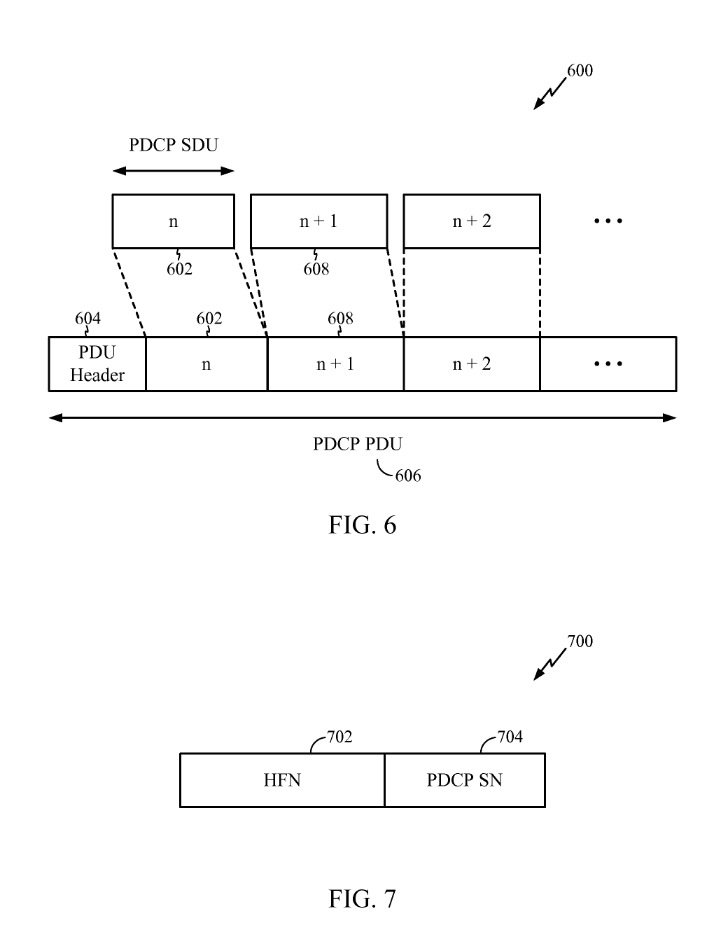

FIG. 6 illustrates example 600 PDCP SDUs and a PDCP PDU 606, in accordance with certain aspects of the present disclosure. As illustrated, one or more PDCP SDUS 602, 608 may be concatenated to generate a PDCP PDU 606. In addition, the PDCP layer adds a PDU header 604 to the PDCP PDU before sending it to other layers.

In a wireless communication system, a transmitter may cipher a packet before transmission to increase data security. For certain aspects, each PDCP SDU in a bundle may be ciphered individually based on a defined value, such as a COUNT variable.

FIG. 7 illustrates an example format for the COUNT variable, in accordance with certain aspects of the present disclosure. The COUNT value may be defined by concatenating a Hyper Frame Number (HFN) 702 and a PDCP sequence number (PDCP SN 704). A hyper frame number may be thought of as high-order bits of the sequence numbers that may not be transmitted with the PDUs. Therefore, a third party may not be able to replicate the cipher and break the encryption.

Each UE may maintain a receiving HFN and a transmitting HFN which are incremented each time a rollover of PDCP sequence number occurs. Similarly, the eNB may maintain a receiving HFN and a transmitting HFN which are incremented each time a rollover of PDCP sequence number occurs.

For certain aspects, the PDCP layer may be linked to an acknowledged mode or an un-acknowledged mode RLC layer. The process of bundling/ciphering and unbundling/deciphering in the PDCP layer may be similar for both modes of the RLC layer.

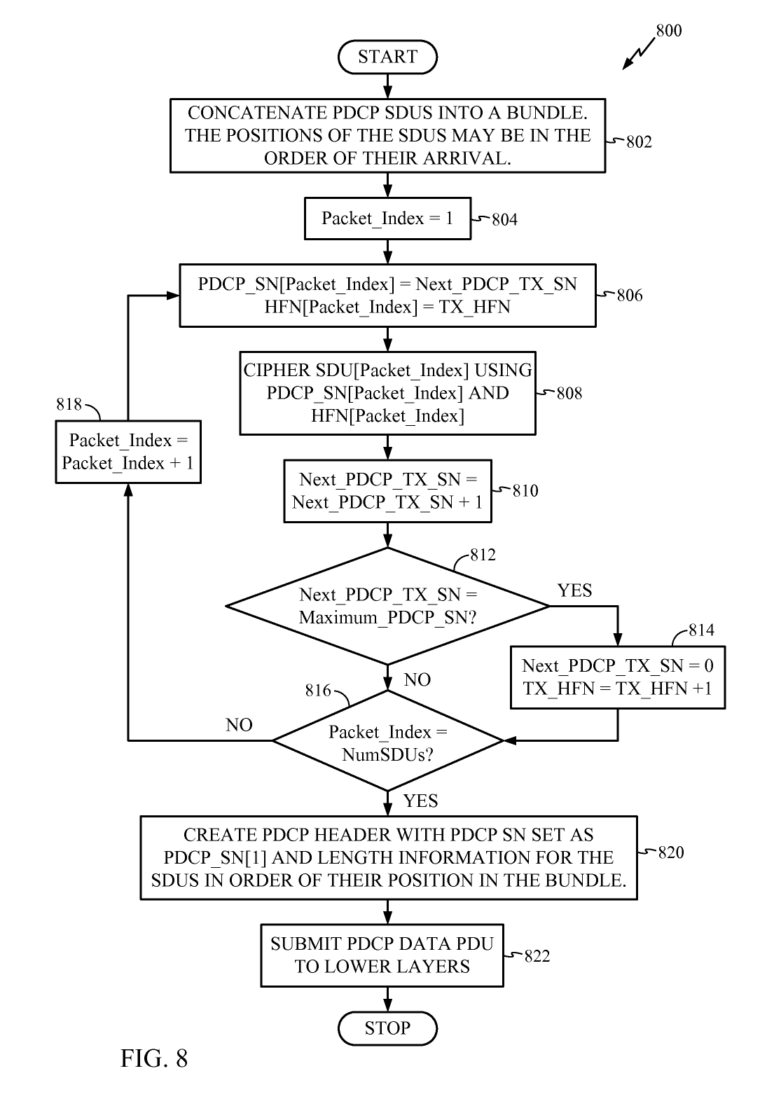

FIG. 8 illustrates an example flow diagram for bundling and individual ciphering of the PDCP SDUs, in accordance with certain aspects of the present disclosure. At 802 the PDCP layer concatenates one or more PDCP SDUs into a bundle. The positions of the SDUs may be in the order of their arrival at the PDCP layer. The variable Packet_index may then be set to 1 at 804.

At 806, the serial number of an SDU in the beginning of the bundle (PDCP_SN[Packet_index]) may be initialized with the value of Next_PDCP_TX_SN, and the hyper frame number of the first SDU in the bundle (HFN[Packet_index]) may be set to TX_HFN. The variable PDCP_SN[k] represents the PDCP_SN for the k^{th} SDU in the bundle. The variable Next_PDCP_TX_SN indicates the PDCP serial number of the next PDCP SDU for a given PDCP entity. The variable HFN[k] is the hyper frame number for the k^{th} SDU in the bundle. The variable TX_HFN indicates the HFN value for generation of the COUNT value used for PDCP PDUs for a given PDCP entity. At establishment of the PDCP entity, TX_HFN may be set to zero.

At 808, the PDCP layer encrypts each PDCP SDU by ciphering the SDU (SDU[Packet_index]) using the values of the PDCP_SN[Packet_index] and the HFN[Packet_index]. At 810, the variable Next_PDCP_TX_SN is incremented by one. Initially, at establishment of the PDCP entity, Next_PDCP_TX_SN may be set to zero.

At 812, if the Next_PDCP_TX_SN has reached a maximum value that the PDCP sequence number can take (based on the size of the buffer space), at 814, the Next_PDCP_TX_SN may be set to zero and the TX_HFN may be incremented by one, and a new SDU may be ready to be bundled and ciphered.

If at 816, the Packet_index is equal to the number of SDUs in the bundle (NumSDUs), execution continues by creating a PDCP header. At 820, the PDCP header may be generated by utilizing the value of the serial number of the first SDU (PDCP_SN[1]) and length information for the one or more SDUs in the order of their position in the bundle. Otherwise, if Packet_index is less than the number of SDUs in the bundle (NumSDUs), execution continues at 818 by incrementing the Packet_index value by one and ciphering the next SDU in the bundle. At 822, the PDCP data PDU is transmitted to lower layers for transmission.

For certain aspects, header compression (if configured) may be performed at any time before ciphering. For even further security, the length information in the header may also be ciphered.

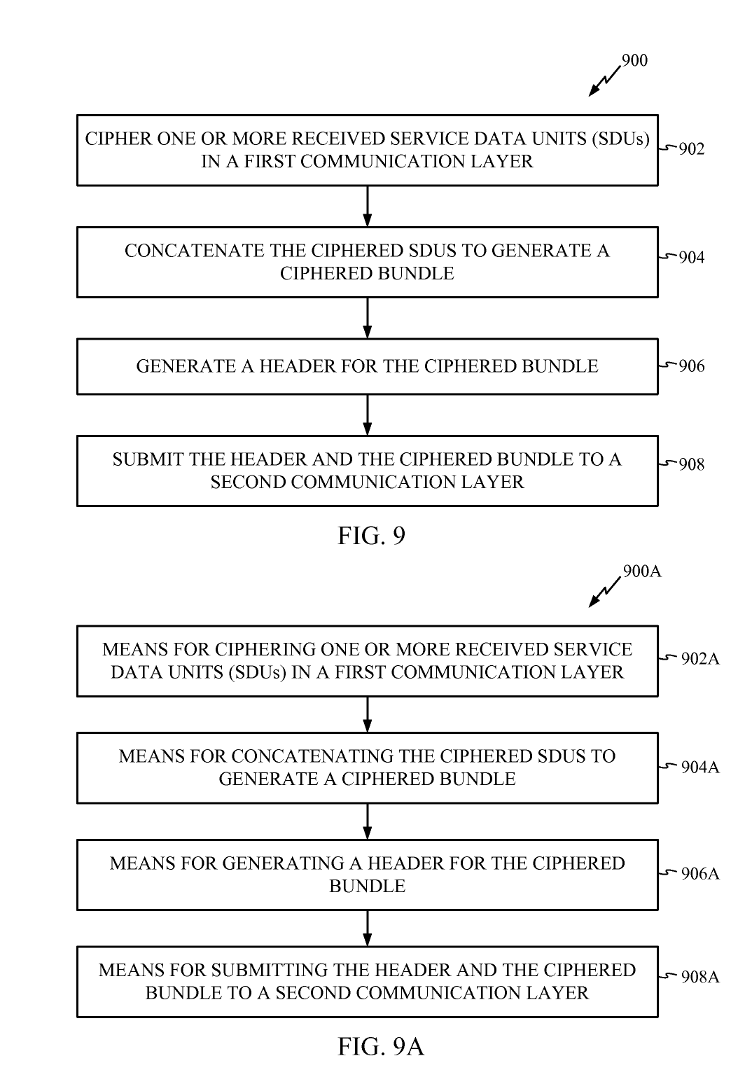

FIG. 9 illustrates example operations for ciphering and bundling service data units, in accordance with certain aspects of the present disclosure. At 902, the transmitter ciphers one or more received SDUs in a first communication layer. At 904, the transmitter concatenates the ciphered SDUs to generate a ciphered bundle. At 906, the transmitter generates a header for the ciphered bundle. At 908, the transmitter submits the header and the ciphered bundle to a second communication layer. As an example, the first communication layer may be a PDCP layer and the second communication layer may be an RLC layer.

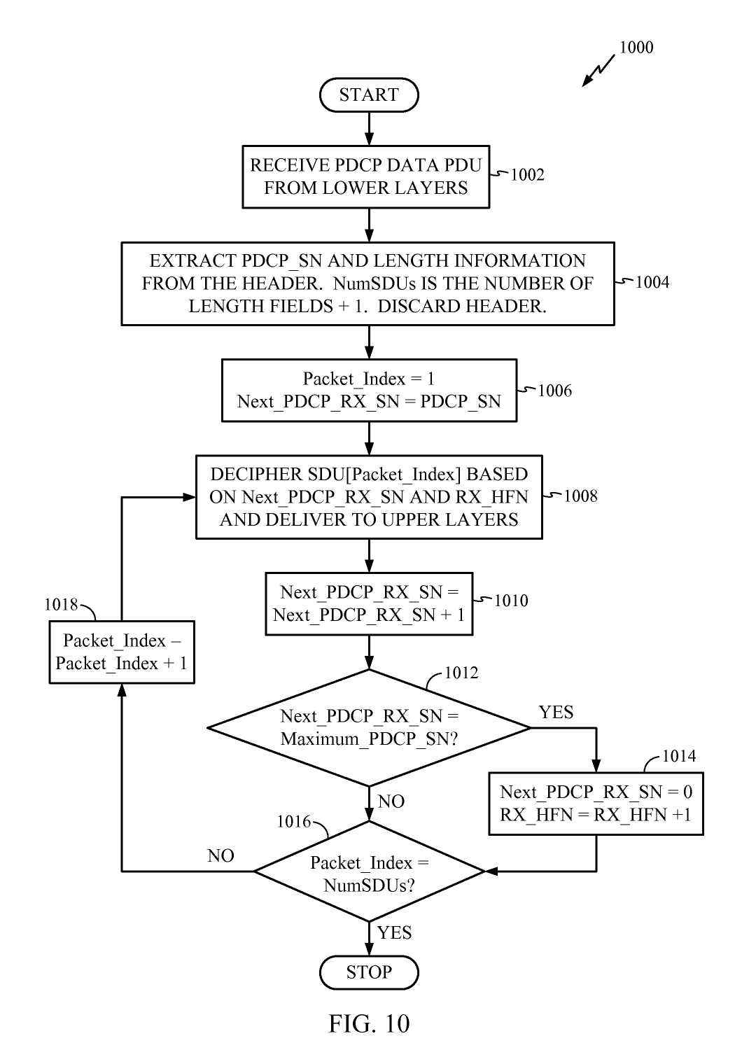

FIG. 10 illustrates an example flow diagram for unbundling and deciphering PDCP SDUs that may be performed by a receiver, in accordance with certain aspects of the present disclosure. At 1002, the PDCP layer may receive a PDCP PDU from lower layers. At 1004, the PDCP layer may extract serial number (PDCP_SN) and length information from the header of the PDCP PDU. For certain aspects, the number of SDUs in the bundle (NumSDUs) may be equal to the number of length fields plus one. For certain aspects, the header may be discarded after extracting the required information. At 1006, the Packet_index may be set equal to one to start deciphering the first SDU in the bundle. In addition, the variable Next_PDCP_SN may be set equal to the value of PDCP_SN.

At 1008, the PDCP layer may decipher the first SDU (SDU[Packet_index]) based on the value of the Next_PDCP_RX_SN and the RX_HFN and deliver the deciphered packet to the upper layers. The variable Next_PDCP_RX_SN indicates the next expected PDCP serial number by the receiver for a given PDCP entity. In addition, the variable RX_HFN indicates the HFN value for the generation of the COUNT value used for the received PDCP PDUs for a given PDCP entity. Initially, at establishment of the PDCP entity, both the Next_PDCP_RX_SN and the RX_HFN may be set to zero.

At 1010, the variable Next_PDCP_RX_SN is incremented by one. Subsequently, at 1012, the Next_PDCP_RX_SN is compared to the maximum allowed serial number for the PDCP layer (Maximum_PDCP_SN). If the Next_PDCP_RX_SN is equal to the Maximum_PDCP_SN, then execution continues to 1014 where the variable Next_PDCP_RX_SN is reset to zero and the variable RX_HFN is incremented by one. Otherwise, the execution continues to 1016 where the Packet_index is compared to the NumSDUs to see if all of the packets in the bundle are deciphered. If not, the execution may continue at 1018 where the Packet_index is incremented by one and the next SDU is deciphered.

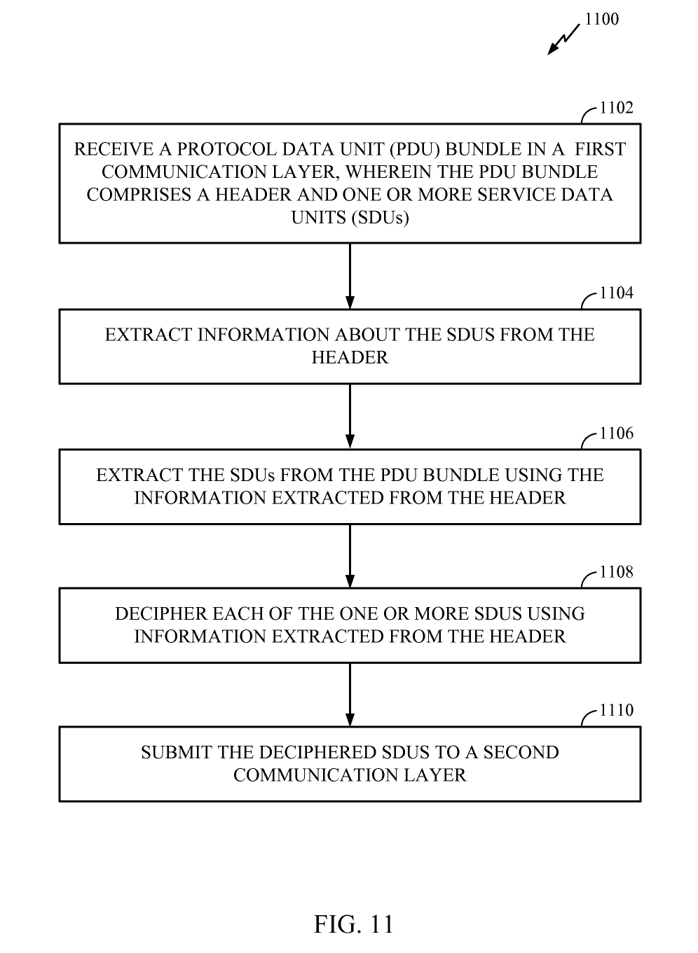

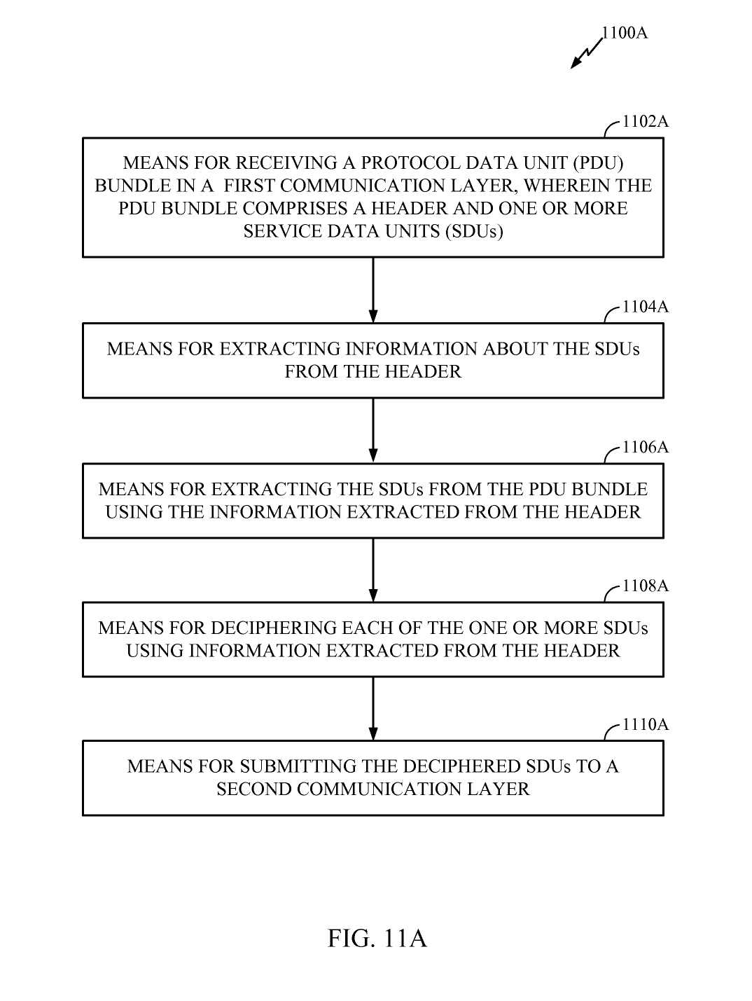

FIG. 11 illustrates example operations for unbundling and deciphering service data units, in accordance with certain aspects of the present disclosure. At 1102, the receiver receives a PDU bundle in a first communication layer, wherein the PDU bundle comprises a header and one or more SDUs. For example, the first communication layer may be a PDCP layer. At 1104, the receiver extracts information about the one or more SDUs from the header. At 1106, the receiver extracts the SDUs from the PDU bundle using the information extracted from the header. At 1108, the receiver deciphers each of the SDUs using information extracted from the header. At 1110, the receiver submits the deciphered SDUs to a higher communication layer.

For certain aspects, if header decompression is activated, the header decompression may be accomplished anytime after deciphering. Additionally, if length information is previously ciphered, deciphering may first be done for the length fields and then the SDU payload.

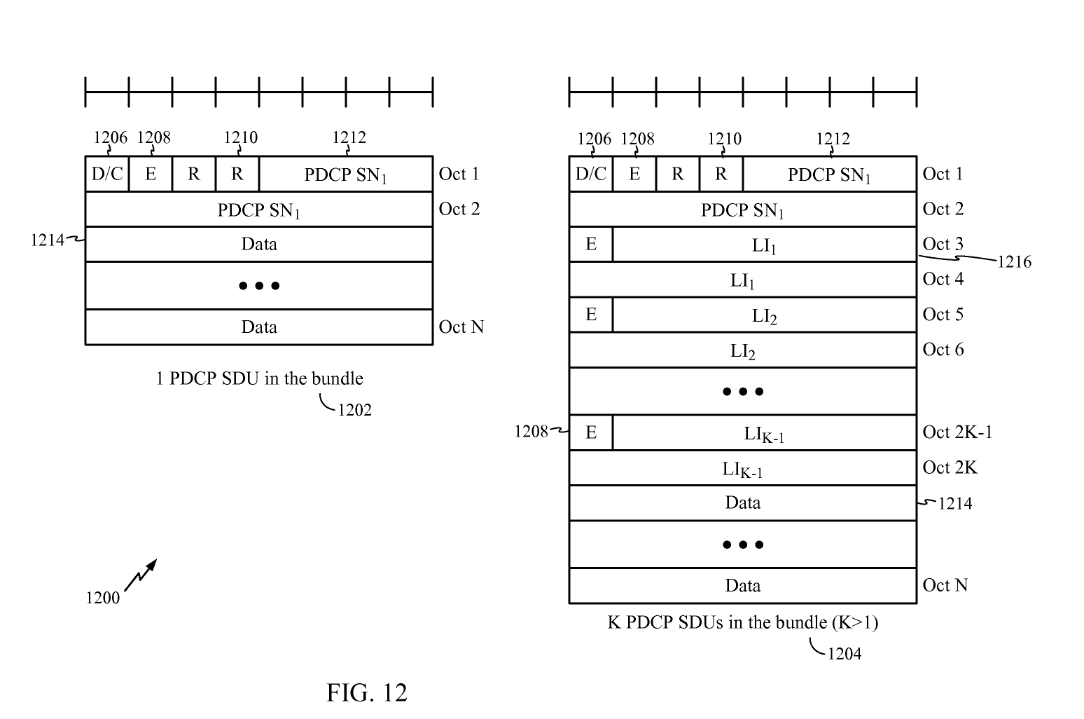

FIG. 12 illustrates an example of a bundling format where ciphering is done individually on each PDCP SDU, in accordance with certain aspects of the present disclosure. In this figure, a single PDCP SDU is illustrated in a bundle 1202 that is arranged by octet bit streams. In addition, K PDCP SDUs are illustrated in a bundle 1204 where K is an integer greater than one. In both bundles, D/C 1206 represents a data/control bit, E 1208 represents an extension bit, R 1210 represents a reserved bit, and the PDCP_SN1 1212 is the PDCP sequence number of the first SDU in the bundle which is represented by 12 bits.

The variable LIⱼ shows the length information 1216 for the j^{th} PDCP SDU which is represented by 15 bits. As illustrated, the serial number for the first SDU in the bundle and the length information for all the K SDUs in the bundle are included in the header of the bundle. The length information of the SDUs is included in the header in a similar order as an order of the SDUs in the bundle, which is followed by the data for all the SDUs.

It should be noted that bundling PDCP SDUs does not cause any issues in the acknowledged mode handover of a UE from a source eNB to a target eNB. During the handover of an acknowledged mode data radio bearer (AM DRB), the source eNB may forward unacknowledged PDCP SDUs (IP packets) in the downlink to the target eNB along with their PDCP_SNs. Since each PDCP SDU in the bundle has a PDCP_SN, bundling does not cause any issues.

In addition, in the uplink, the source eNB may forward out-of-sequence received PDCP SDUs to the target eNB. Since the PDCP_SN for all the PDCP SDUs in the bundle may be inferred from the PDCP_SN of the first PDCP SDU, which is contained in the header, bundling does not cause any issues in the uplink either.

Certain embodiments of the present disclosure proposed techniques for bundling and ciphering SDUs in a communication layer. Each SDU may be ciphered individually based on a COUNT value. For certain embodiments, ciphering may be done before or after bundling of SDUs.

The various operations of methods described above may be performed by various hardware and/or software component(s) and/or module(s) corresponding to means-plus-function blocks illustrated in the Figures. For example, blocks 902-908 illustrated in FIG. 9 correspond to means-plus-function blocks 902A-908A illustrated in FIG. 9A. In addition, blocks 1102-1110 illustrated in FIG. 11 correspond to means-plus-function blocks 1102A-1110A illustrated in FIG. 11A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
ciphering one or more received service data units (SDUs) in a first communication layer;
concatenating the ciphered SDUs to generate a bundle;
generating a header for the bundle; and
submitting the header and the bundle to a second communication layer.

2. The method of claim 1, wherein the SDUs are ciphered based on a defined value.

3. The method of claim 2, wherein the defined value is generated by concatenating a hyper frame number and a serial number.

4. The method of claim 1, wherein the first communication layer is a packet data convergence protocol (PDCP) layer.

5. The method of claim 1, wherein the second communication layer is a radio link control (RLC) layer.

6. The method of claim 1, wherein the header comprises a serial number of the ciphered SDU in the beginning of the bundle and length information for all the ciphered SDUs in the bundle.

7. The method of claim 6, wherein the length information of the ciphered SDUs is included in the header in a similar order as an order of the ciphered SDUs in the bundle.

8. The method of claim 1, wherein the concatenating is performed in order of arrival of the SDUs.

9. A method for wireless communications, comprising:
receiving a protocol data unit (PDU) bundle in a first communication layer, wherein the PDU bundle comprises a header and one or more service data units (SDUs);
extracting information about the SDUs from the header;
extracting the SDUs from the PDU bundle using the information extracted from the header;
deciphering each of the SDUs using the information extracted from the header; and
submitting the deciphered SDUs to a higher communication layer.

10. The method of claim 9, wherein the first communication layer is a packet data convergence protocol (PDCP) layer.

11. The method of claim 9, wherein the information extracted from the header comprises a serial number and length information for the SDUs.

12. The method of claim 9, wherein number of SDUs in the bundle is equal to number of length fields in the header plus one.

13. The method of claim 9, wherein the deciphering is performed based on a defined value.

14. The method of claim 13, wherein the defined value is generated by concatenating a hyper frame number and a serial number.

15. An apparatus for wireless communications, comprising:
logic for ciphering one or more received service data units (SDUs) in a first communication layer;
logic for concatenating the ciphered SDUs to generate a bundle;
logic for generating a header for the bundle; and
logic for submitting the header and the bundle to a second communication layer.

16. The apparatus of claim 15, wherein the SDUs are ciphered based on a defined value.

17. The apparatus of claim 16, wherein the defined value is generated by concatenating a hyper frame number and a serial number.

18. The apparatus of claim 15, wherein the first communication layer is a packet data convergence protocol (PDCP) layer.

19. The apparatus of claim 15, wherein the second communication layer is a radio link control (RLC) layer.

20. The apparatus of claim 15, wherein the header comprises a serial number of the ciphered SDU in the beginning of the bundle and length information for all the ciphered SDUs in the bundle.

21. The apparatus of claim 20, wherein the length information of the ciphered SDUs is included in the header in a similar order as an order of the ciphered SDUs in the bundle.

22. The apparatus of claim 15, wherein the concatenating is performed in order of arrival of the SDUs.

23. An apparatus for wireless communications, comprising:
logic for receiving a protocol data unit (PDU) bundle in a first communication layer, wherein the PDU bundle comprises a header and one or more service data units (SDUs);
logic for extracting information about the SDUs from the header;
logic for extracting the SDUs from the PDU bundle using the information extracted from the header;
logic for deciphering each of the SDUs using the information extracted from the header; and
logic for submitting the deciphered SDUs to a higher communication layer.

24. The apparatus of claim 23, wherein the first communication layer is a packet data convergence protocol (PDCP) layer.

25. The apparatus of claim 23, wherein the information extracted from the header comprises a serial number and length information for the SDUs.

26. The apparatus of claim 23, wherein number of SDUs in the bundle is equal to number of length fields in the header plus one.

27. The apparatus of claim 23, wherein the deciphering is performed based on a defined value.

28. The apparatus of claim 27, wherein the defined value is generated by concatenating a hyper frame number and a serial number.

29. An apparatus for wireless communications, comprising:
means for ciphering one or more received service data units (SDUs) in a first communication layer;
means for concatenating the ciphered SDUs to generate a bundle;
means for generating a header for the bundle; and
means for submitting the header and the bundle to a second communication layer.

30. An apparatus for wireless communications, comprising:
means for receiving a protocol data unit (PDU) bundle in a first communication layer, wherein the PDU bundle comprises a header and one or more service data units (SDUs);
means for extracting information about the SDUs from the header;
means for extracting the SDUs from the PDU bundle using the information extracted from the header;
means for deciphering each of the SDUs using the information extracted from the header; and
means for submitting the deciphered SDUs to a higher communication layer.

31. A computer-program product for wireless communications, comprising a computer readable medium having instructions stored thereon, the instructions being executable by one or more processors and the instructions comprising:
instructions for ciphering one or more received service data units (SDUs) in a first communication layer;
instructions for concatenating the ciphered SDUs to generate a bundle;
instructions for generating a header for the bundle; and
instructions for submitting the header and the bundle to a second communication layer.

32. A computer-program product for wireless communications, comprising a computer readable medium having instructions stored thereon, the instructions being executable by one or more processors and the instructions comprising:
instructions for receiving a protocol data unit (PDU) bundle in a first communication layer, wherein the PDU bundle comprises a header and one or more service data units (SDUs);
instructions for extracting information about the SDUs from the header;
instructions for extracting the SDUs from the PDU bundle using the information extracted from the header;
instructions for deciphering each of the SDUs using the information extracted from the header; and
instructions for submitting the deciphered SDUs to a higher communication layer.

33. An apparatus for wireless communications, comprising at least one processor configured to:
cipher one or more received service data units (SDUs) in a first communication layer;
concatenate the ciphered SDUs to generate a bundle;
generate a header for the bundle; and
submit the header and the bundle to a second communication layer.

34. An apparatus for wireless communications, comprising at least one processor configured to:
receive a protocol data unit (PDU) bundle in a first communication layer, wherein the PDU bundle comprises a header and one or more service data units (SDUs);
extract information about the SDUs from the header;
extract the SDUs from the PDU bundle using the information extracted from the header;
decipher each of the SDUs using the information extracted from the header; and
submit the deciphered SDUs to a higher communication layer.
